(19) United States
(12) Patent Application Publication
(10) Pub. No.: US 2007/0114243 A1
(43) Pub. Date: May 24, 2007

(54) Beverage dispense

(75) Inventors: David Kershaw, Norfolk (GB); Andrew Lager, Essex (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BRITVIC SOFT DRINKS LIMITED, Essex (GB)

(21) Appl. No.: 11/287,168

(22) Filed: Nov. 22, 2005

(51) Int. Cl. B67D 5/56

(52) U.S. Cl. 222/129.1

(57) ABSTRACT

A beverage dispense system comprising a source of a first fluid, a source of a second fluid, a control unit for measuring and mixing the first and second fluids in a pre-determined ratio to produce a beverage for dispense, the control unit including measuring means for delivering the first and second fluids to blending means for mixing the first and second fluids in the pre-determined ratio, and supply means for supplying the beverage to dispense means for dispensing the beverage.

This invention concerns improvements in or relating to beverage dispense. More specifically, the invention concerns systems for mixing two fluids in a pre-determined ratio and dispensing a beverage. The invention has particular, but not exclusive, application to the dispense of soft drinks formed by mixing a diluent and a concentrate. The diluent may be water and the concentrate a syrup. The water may be still or carbonated.

Beverage dispense systems for soft drinks are traditionally either pre-mix or post-mix. In a pre-mix system the beverage is supplied to the end user (retailer) already made-up with the diluent and concentrate mixed in the required proportions for dispense of the beverage. The beverage may be carbonated or uncarbonated and the dispense system may include means for in-line cooling of the beverage prior to dispense through a nozzle into a drinking cup. The relative proportions of the diluent and concentrate can be accurately controlled during manufacture and the quality of the beverage is assured. However, pre-mixing adds to costs for both the manufacturer and end user.

In a typical post-mix beverage dispense system, sources of diluent and concentrate are connected to a mixing nozzle at the point of dispense via flow control valves for admitting measured volumes of diluent and concentrate to the mixing nozzle where they are mixed together and then dispensed through the nozzle into a drinking cup. This adds to the complexity and hence cost of the dispense valves employed in post-mix systems compared to pre-mix systems.

The post-mix system allows the manufacturer to supply the end user with concentrate only for mixing with the diluent. This reduces production costs for the manufacturer and the end user can use mains water as the diluent for dispense of still beverages or, with a carbonator to carbonate the water, carbonated beverages.

Mixing the diluent and concentrate at the point of dispense in such systems can have an adverse affect on the quality of the dispensed beverage from one dispense to the next. In particular, variations in the temperature and/or pressure of water and/or concentrate supplies can cause variations in the relative properties of the water and concentrate in the dispensed beverage.

Moreover, the end user (retailer) may attempt to reduce costs by making adjustments to the dispense valve to alter the relative proportions of the diluent and concentrate in the dispensed beverage, typically reducing the amount of the more expensive concentrate, which has an adverse effect on the quality of the dispensed beverage.

Furthermore, for dispense of carbonated beverages, mixing of carbonated water with uncarbonated concentrate at the point of dispense reduces the carbonation level of the dispensed beverage and can result in problems caused by carbon dioxide coming out of solution. This is referred to as “break-out” and can cause excessive foaming in the dispense nozzle and drinking cup. This reduces the carbon dioxide level affecting the quality of the dispensed beverage.

In addition, the dispensed beverage is typically chilled and requires both the diluent and concentrate to be supplied to the mixing chamber at a sufficiently low temperature, typically less than 5° C. for dispense of the chilled beverage. Where the concentrate is a syrup, this can lead to incomplete mixing of the syrup and diluent in the dispensed beverage, again affecting the quality of the dispensed beverage.

A further problem of post-mix systems is that water present in the water line up to the mixing nozzle is in contact with the open air. As a result, the water can be contaminated with airborne micro-organisms causing microbiological growth to occur in the water line. This is a particular problem when the water line contains carbonated water and necessitates regular cleaning to remove any growth that could affect the quality of the beverage and present a health risk. This problem is significantly reduced or avoided in pre-mix dispense systems where the beverage is in contact with air but contains ingredients (preservatives) that prevent or deter microbiological growth.

The present invention has been made from a consideration of the foregoing problems or disadvantages of beverage dispense systems.

According to a first aspect of the present invention, there is provided a beverage dispense system comprising a source of a first fluid, a source of a second fluid, a control unit for measuring and mixing the first and second fluids in a pre-determined ratio to produce a beverage for dispense, the control unit including measuring means for delivering the first and second fluids in the pre-determined ratio to blending means for mixing the first and second fluids, and supply means for supplying the beverage to dispense means for dispensing the beverage.

The predetermined ratio of the first and second fluids may be delivered to the blending means in separate lines or in the same line.

By this invention, the control unit for measuring and mixing the two fluids to produce the beverage can be installed between the fluid sources and the dispense means. As a result, separate supply lines from each fluid source to the dispense means for measuring and mixing the fluids at the dispensing head can be avoided. More particularly, the control unit can be positioned at any convenient location, for example, under the counter top or in a cellar or other remote location.

By mixing the two fluids in the control unit, the quality of the dispensed beverage can be controlled more reliably. In this way, the present invention enables the advantages of a pre-mix system with accurate mixing of the fluids for quality control to be combined with the benefits of a post-mix system for on-site mixing of the fluids. Thus, the dispense system of the present invention may be considered as a hybrid of pre-mix and post-mix dispense systems.

The control unit may include conditioning means for modifying one or more properties of the mixed fluids. For example, the conditioning means may alter the temperature of the beverage to be dispensed. Alternatively, or additionally, the conditioning means may control the carbonation level of the beverage to be dispensed.

The conditioning means may be separate from the blending means. Alternatively, the conditioning means may be combined with the blending means. In this way, the temperature, and/or carbonation level of the mixed fluids may be controlled before, during, or after blending in the blending means.

In one embodiment, the mixed fluids are optionally carbonated for dispense of carbonated or uncarbonated beverages. By carbonating the mixed fluids, the carbonation level of the dispensed beverage may be enhanced by absorption of carbon dioxide in both the diluent and concentrate. The mixed fluids may be carbonated in the blending means, or in the line/pipe delivering the fluids to the blending means or in the line/pipe between the blending and dispense means, or a combination thereof. Alternatively the system may include a separate carbonation means in which the mixed fluids are carbonated, the carbonation means may be an in-line device.

The system may be arranged to dispense one beverage, alternatively the system may be arranged to include additional fluid sources and additional control units thereby allowing dispense of more than one beverage.

According to a second aspect of the present invention, there is provided a beverage dispense system comprising a source of a first fluid, a source of a second fluid, means for mixing the first and second fluids in a pre-determined ratio to produce a beverage for dispense, means for optionally carbonating the beverage, and supply means for supplying the beverage to dispense means for dispensing the beverage.

By this arrangement, the first and second fluids can be mixed to produce a beverage that can be dispensed as either a carbonated or uncarbonated beverage.

The carbonating means may be separate from or combined with the mixing means. The mixing means may be separate from or combined with metering means for supplying the fluids to the mixing means in the pre-determined ratio.

The metering means, mixing means and carbonating means may be provided in a control unit for installation between the fluid sources and the dispenser.

According to a third aspect of the invention there is provided a method of dispensing a beverage by providing sources of first and second fluids, providing means for mixing the first and second fluids in a pre-determined ratio, providing means for optionally carbonating the beverage, and providing means for dispensing either carbonated or uncarbonated beverage.

The invention will now be described in more detail by way of example only with reference to the accompanying drawings in which like reference numerals are used throughout to indicate corresponding parts and wherein:

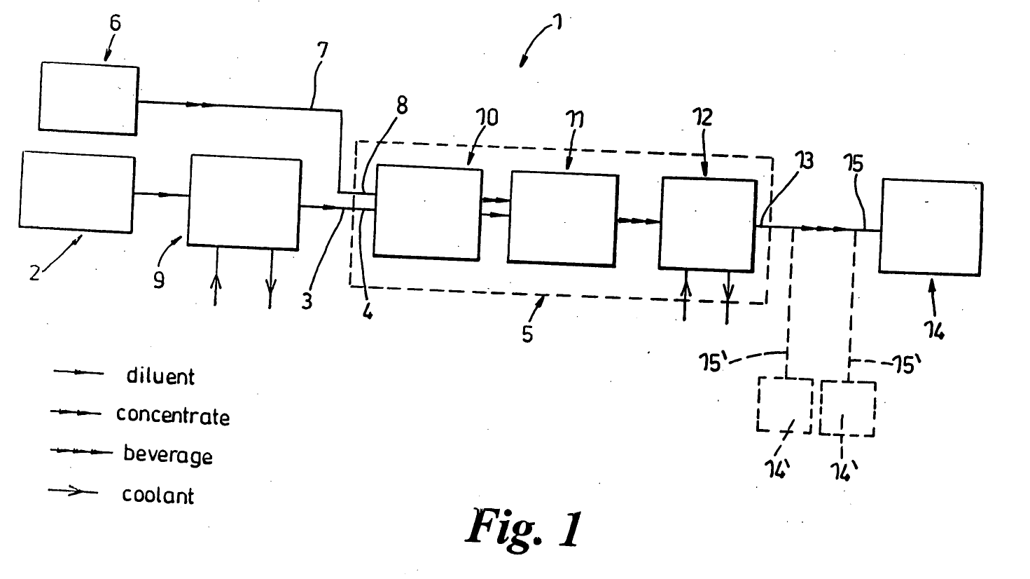

FIG. 1 is a diagrammatic representation of a beverage dispense system according to a first embodiment of the invention;

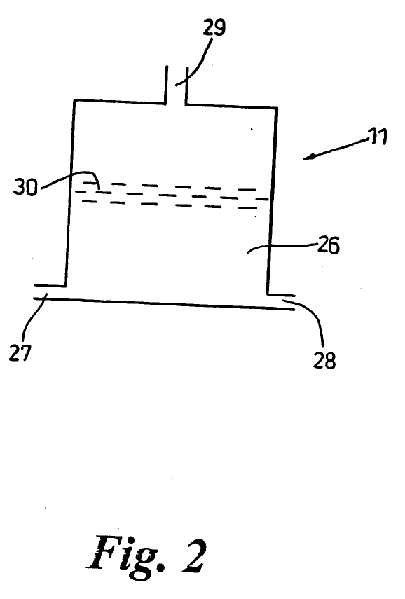

FIG. 2 is a diagrammatic representation of a mixing chamber for blending the measured volumes of fluid;

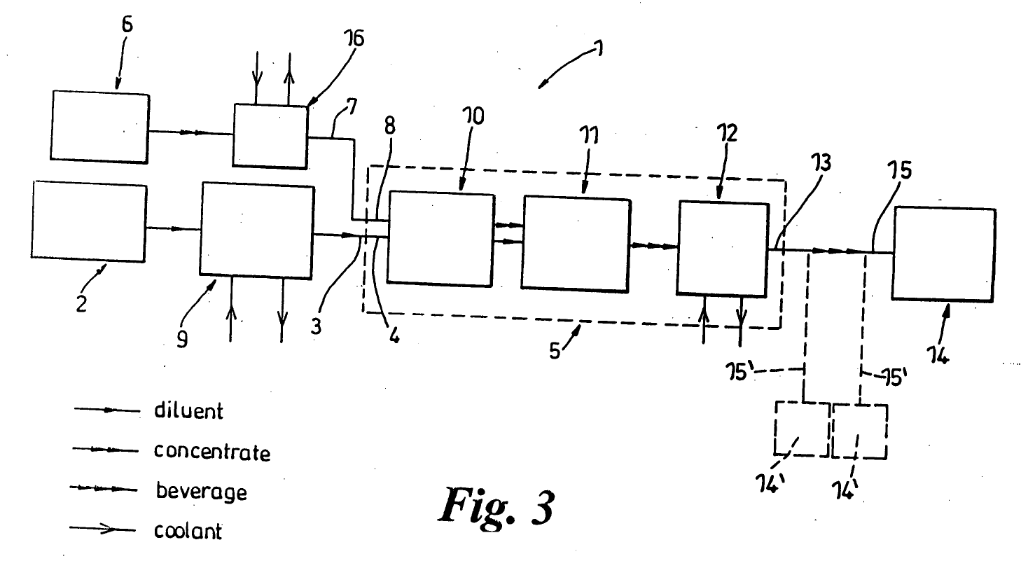

FIG. 3 is a diagrammatic representation of a beverage dispense system according to a second embodiment of the invention;

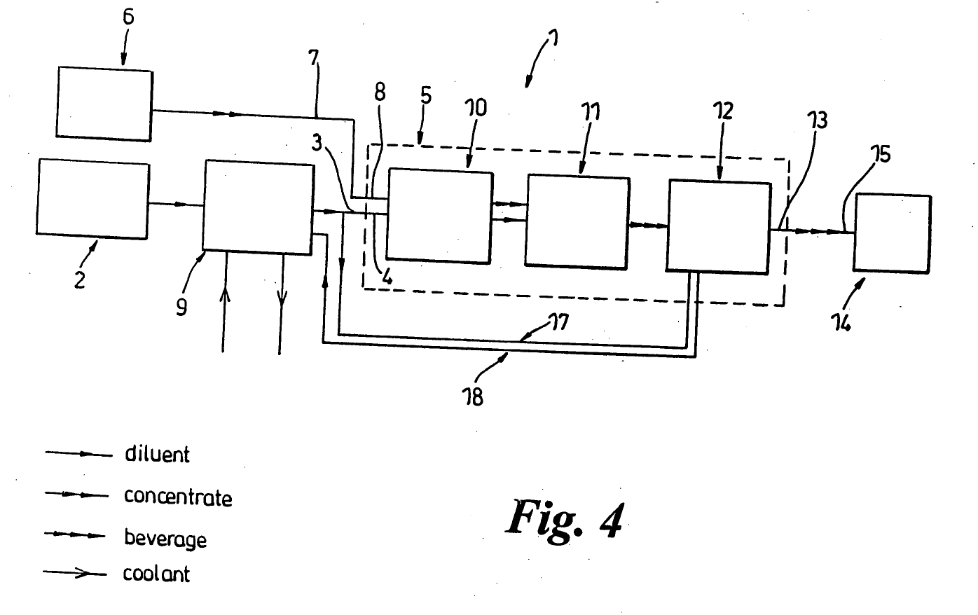

FIG. 4 is a diagrammatic representation of a beverage dispense system according to a third embodiment of the invention;

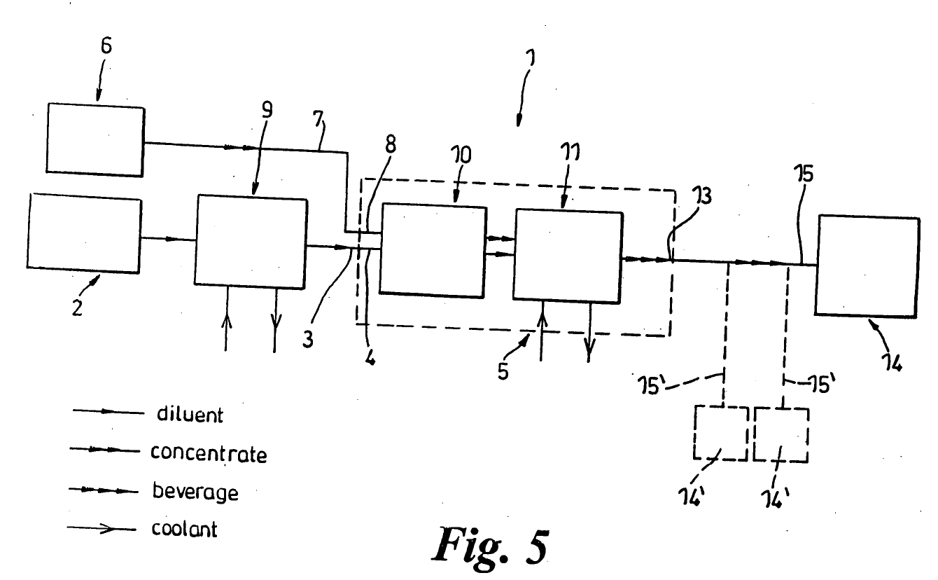

FIG. 5 is a diagrammatic representation of a beverage dispense system according to a fourth embodiment of the invention;

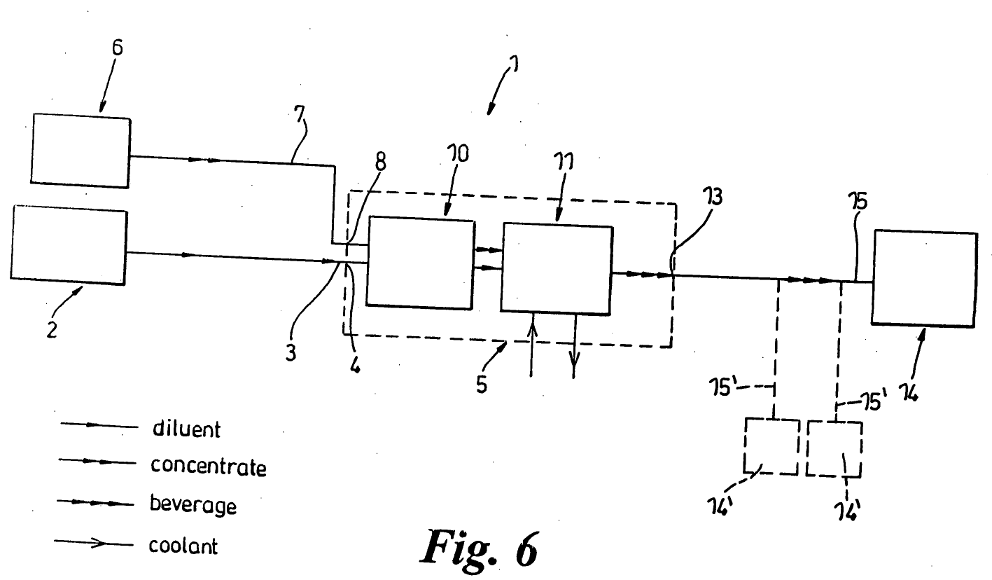

FIG. 6 is a diagrammatic representation of a beverage dispense system according to a fifth embodiment of the invention;

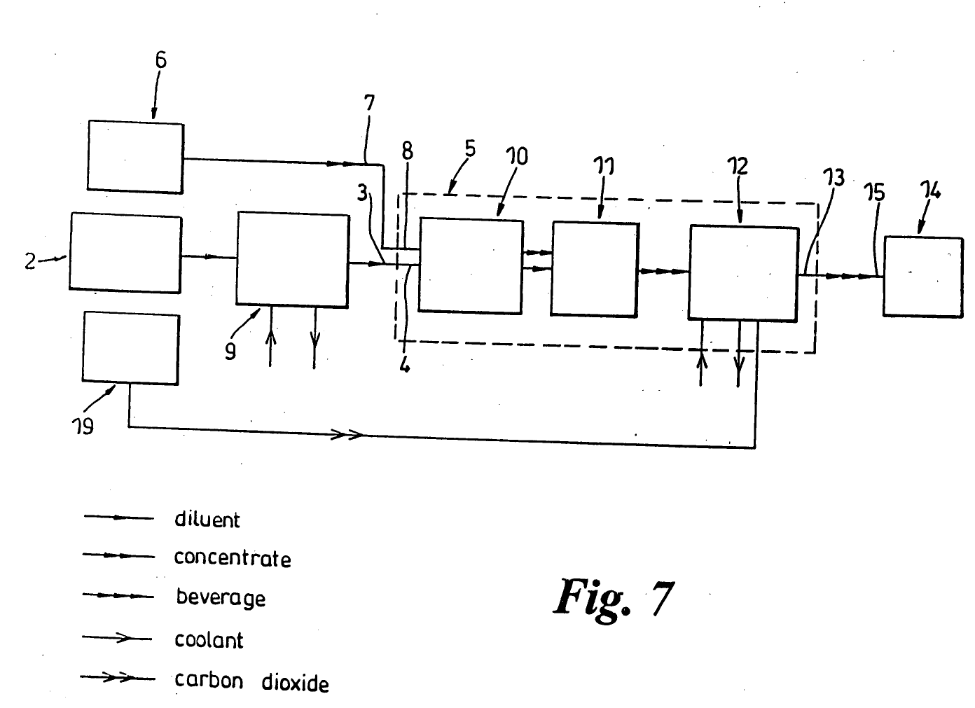

FIG. 7 is a diagrammatic representation of a beverage dispense system according to a sixth embodiment of the invention;

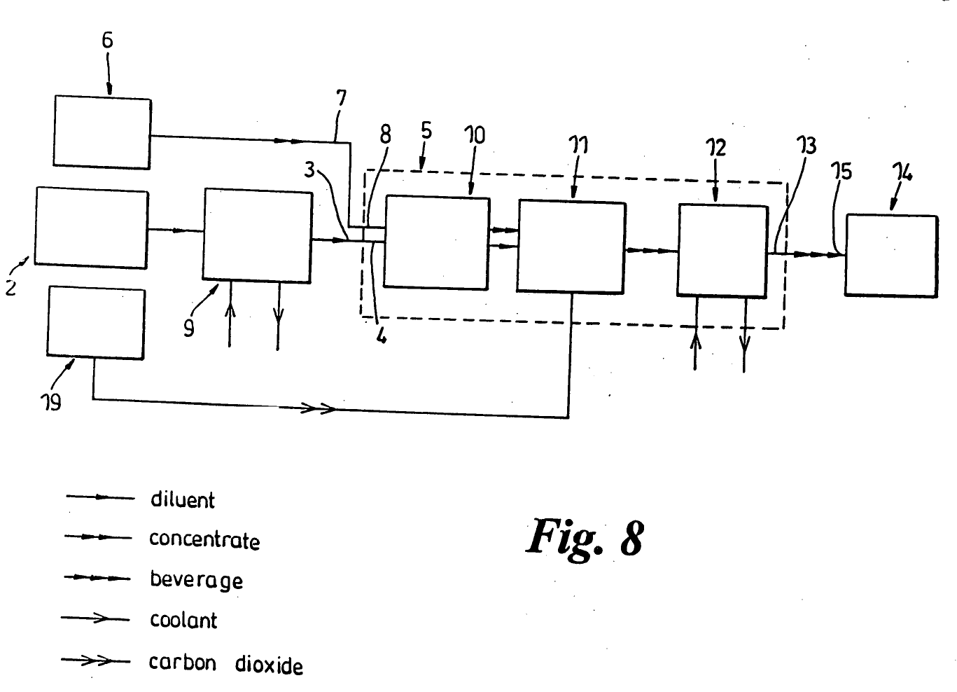

FIG. 8 is a diagrammatic representation of a beverage dispense system according to a seventh embodiment of the invention;

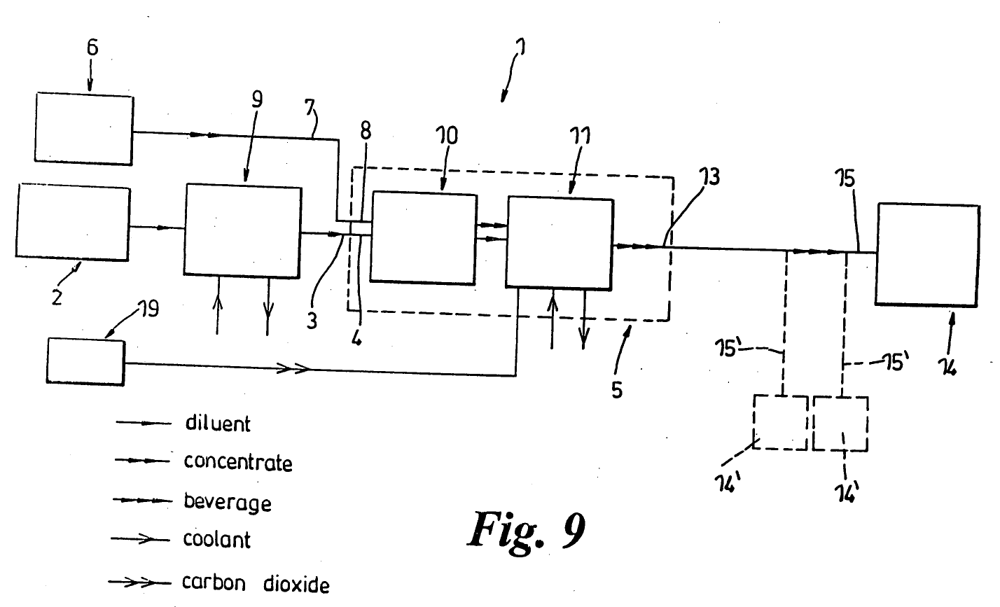

FIG. 9 is a diagrammatic representation of a beverage dispense system according to an eighth embodiment of the invention;

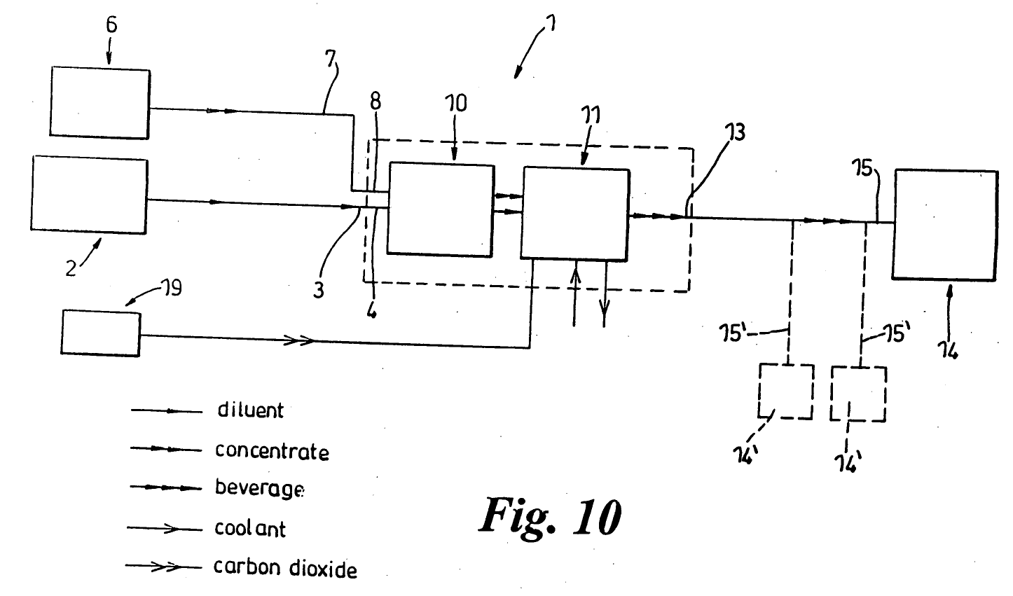

FIG. 10 is a diagrammatic representation of a beverage dispense system according to a ninth embodiment of the invention;

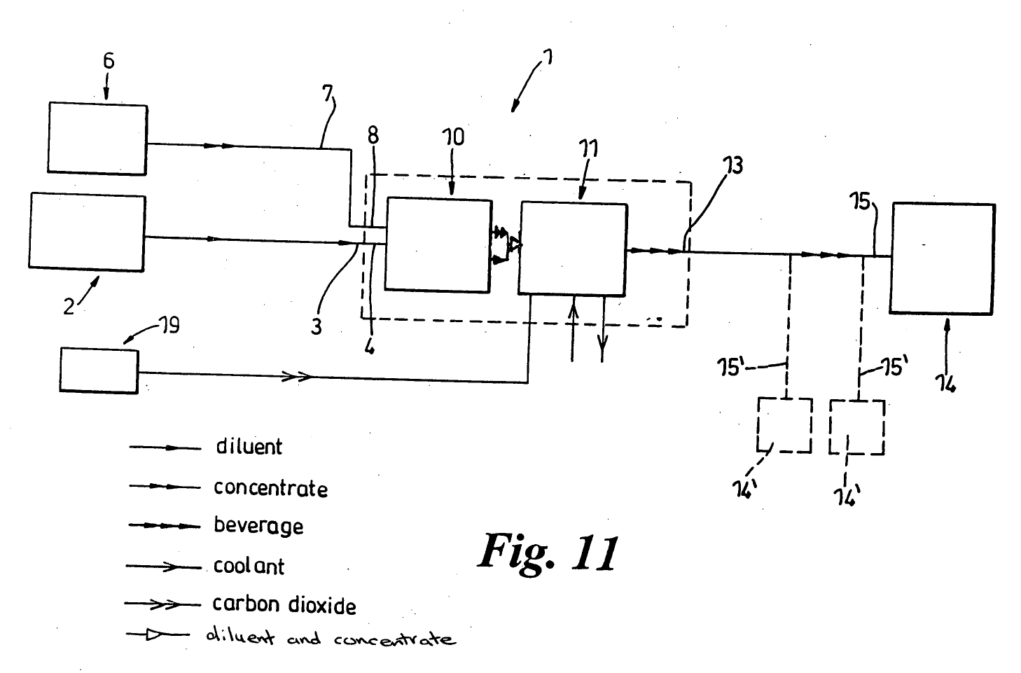

FIG. 11 is a diagrammatic representation of a beverage dispense system according to a tenth embodiment of the invention;

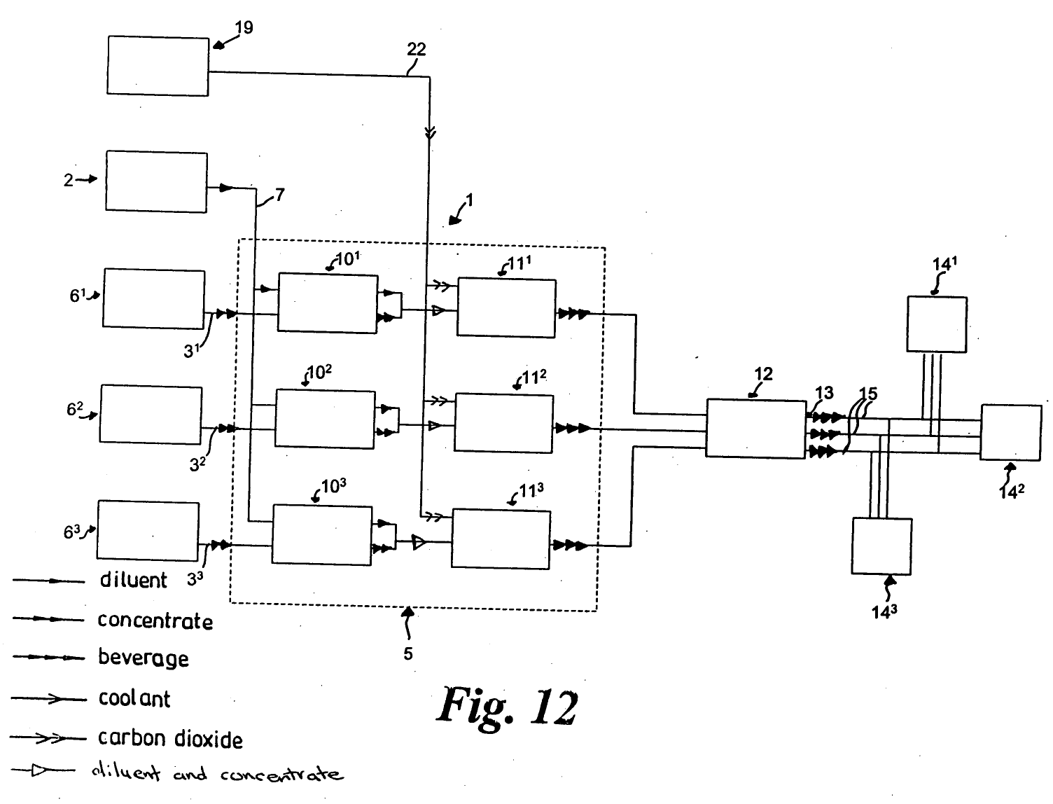

FIG. 12 is a diagrammatic representation of a beverage dispense system according to an eleventh embodiment of the invention;

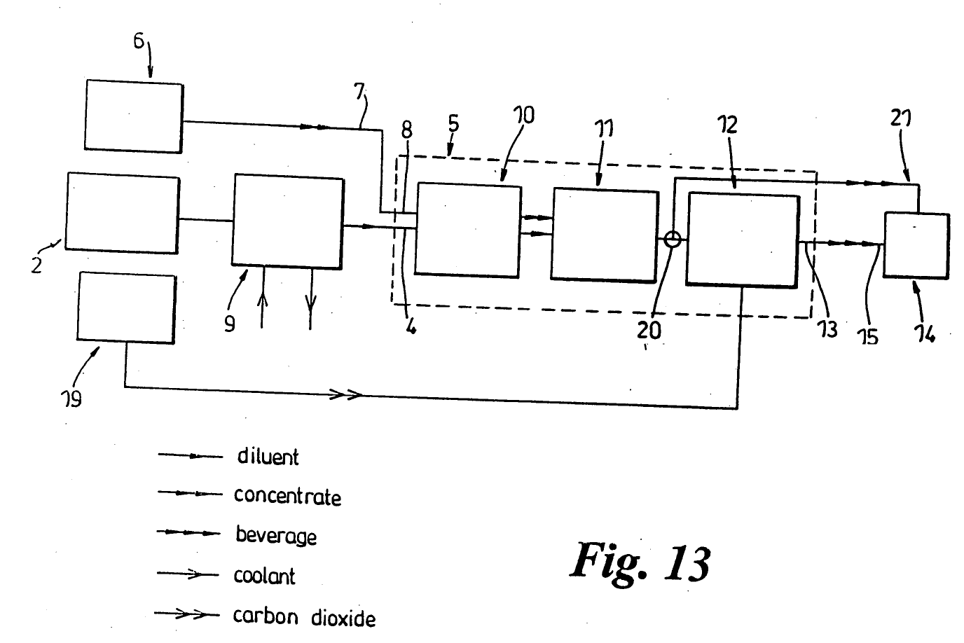

FIG. 13 is a diagrammatic representation of a beverage dispense system according to a twelfth embodiment of the invention; and

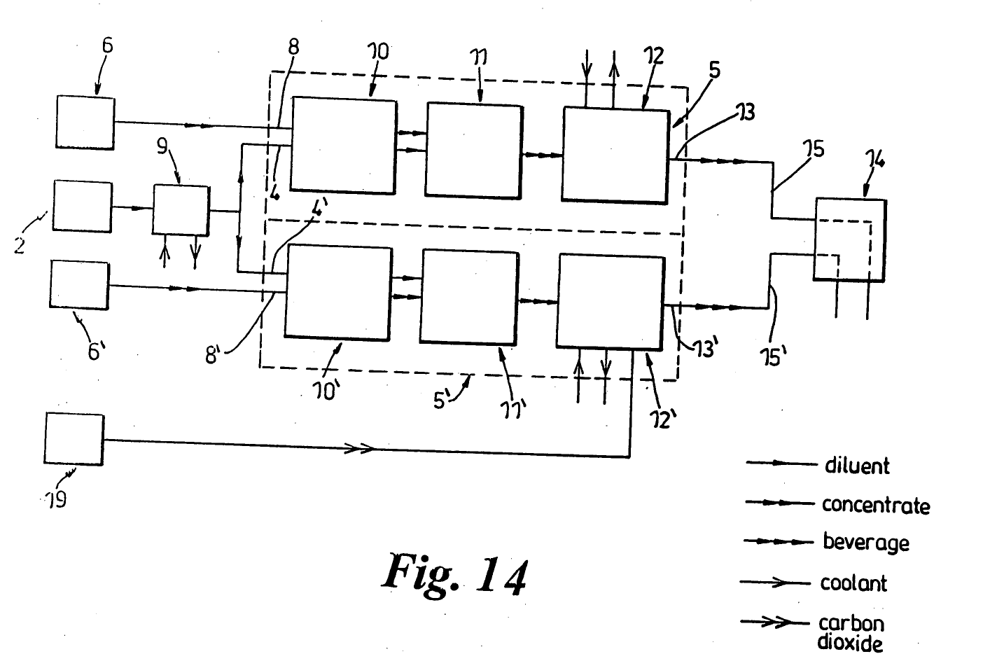

FIG. 14 is a diagrammatic representation of a beverage dispense system according to a thirteenth embodiment of the invention;

Referring first to FIG. 1 of the accompanying drawings, a beverage dispense system 1 is shown for dispensing a soft drink by measuring and mixing a diluent and a concentrate in a pre-determined ratio. The diluent may be water (still or carbonated) and the concentrate may be a syrup. For example the system 1 may dispense carbonated beverages such as cola or still beverages such as fruit juices. As shown, a source 2 of diluent is supplied in line 3 to a control unit 5 and a source 6 of concentrate is supplied in line 7 to the control unit 5.

The line 3 includes a heat exchange device 9 for cooling the diluent to a temperature in the range 0° C. to 5° C., typically around 3° C., for supply to the control unit 5. The heat exchange device 9 may be of any suitable type to cool the diluent to the required temperature. For example, the heat exchange device 9 may cool the diluent by heat exchange with a coolant circulated through the device. Alternatively, the heat exchange device 9 may be a peltier device. The concentrate is supplied to the control unit 5 at ambient temperature.

The control unit 5 includes metering device 10, a blending/mixing device 11 and a conditioning device 12. The lines 3, 7 are connected to inlets 4, 8 of the metering device 10 for measuring and supplying diluent and concentrate to the blending device 11 in the pre-determined ratio to produce the beverage to be dispensed. Mixing of the concentrate is assisted by supplying the concentrate at ambient temperature.

From the blending device 11 the beverage is passed through the conditioning device 12 to cool the beverage to the desired dispense temperature, typically around 3° C. The conditioning device 12 may cool the beverage by heat exchange with a coolant circulated through the device 12. Alternatively, the device 12 may be a peltier device.

The cooled beverage is supplied to a beverage dispenser 14 in a line 15 connected to an outlet 13 of the conditioning device 12. The line 15 may be cooled to maintain the beverage at the desired dispense temperature. For example, the line 15 may be incorporated in a so-called ‘python’ containing a bundle of fluid lines including one or more beverage lines for dispense of beverages and a coolant re-circulation line for maintaining the beverage(s) at the desired temperature.

As will now be appreciated, the control unit 5 can be located at any point between the sources 2, 6 of diluent and concentrate and the dispenser 14 for dispensing the beverage. The control unit 5 may be placed under a counter top in a bar or similar location or at any other convenient location. The control unit 5 provides a supply of beverage having the required ratio of diluent to concentrate that has been thoroughly mixed and cooled to the required dispense temperature prior to delivery to the dispenser 14 for dispense into a drinking cup (not shown) via a suitable dispense valve (not shown).

In this way, the quality of the dispensed beverage can be controlled in a reliable manner. In particular, mixing the fluids on site prior to the point of dispense allows both carbonated and uncarbonated beverages to be dispensed that combine the benefits of pre-mix and post-mix systems. Moreover, carbonated beverages can be dispensed without significant problems from carbon dioxide “break-out” associated with traditional post-mix dispense systems. Furthermore, the dispense valve may be of type typically employed in pre-mix dispense systems in preference to the more complicated and costly dispense valves required for post-mix dispense systems. Additionally, the risk of airborne micro-organisms that come into contact with the beverage at the point of dispense causing microbiological growth in the beverage line is reduced or eliminated by the ingredients (preservatives) in the beverage and contamination of the beverage line and associated health risks associated with post-mix dispense systems are largely avoided.

In a modification, the line 15 may supply additional dispensers 14′ via branch lines 15′ as shown in outline in FIG. 1. In this way, the control unit 5 can supply a plurality of dispensers 14,14′ at different locations.

Referring now to FIG. 2 there is shown diagrammatically, a possible construction for the blending device 11. As shown the device 11 comprises a chamber 26 having inlets 27, 28 at the bottom for delivery of the diluent and concentrate in the pre-determined ratio from the metering device 10. The inlets 27, 28 are provided on opposite sides of the chamber 26 to direct the incoming fluid flows towards each other. If the diluent and concentrate have been brought together in the same line before entry into the blending means then only one inlet into the chamber will be needed (not shown). The chamber 26 has an outlet 29 at the top and the incoming diluent and concentrate flows pass upwardly through a grid 30 that causes the flows to mix and blend thoroughly prior to exiting the chamber 26 through the outlet 29. By positioning the outlet 29 at the top of the chamber 26, any air or gas can escape and does not remain in the chamber 26 where it may affect the quality of the beverage.

Referring now to FIG. 3 there is shown a second embodiment of the beverage dispense system 1 in which the concentrate is cooled prior to delivering to the control unit 5 by a heat exchange device 16 located in the supply line 7. The heat exchange device 16 may cool the concentrate by heat exchange with coolant circulated through the device 16. Alternatively, the heat exchange device 16 may be a peltier device. The device 16 may cool the concentrate to a temperature in the range of 0° C. to 5° C., typically around 3° C. In this embodiment, both the concentrate and diluent are cooled prior to metering and blending. As a result, additional cooling of the beverage produced by metering and mixing the diluent and concentrate may not be required and the conditioning device 12 may be omitted.

Referring now to FIG. 4 there is shown a third embodiment of the beverage dispense system 1 in which the coolant for cooling the beverage in the conditioning device 12 is provided by diluent that has been cooled in the heat exchange device 9. As shown, the cooled diluent passes to the conditioning device 12 in line 17 and returns to the heat exchange device 9 in line 18. In this way, the beverage is cooled to substantially the same temperature as the diluent. The concentrate may be supplied to the unit 5 at ambient temperature as in FIG. 1 or pre-cooled as in FIG. 3.

Referring now to FIG. 5 there is shown a fourth embodiment of a beverage dispense system in which the conditioning device 12 is omitted and, where required, additional cooling of the beverage is provided in the mixing device 11. For example, coolant may be circulated through coils wrapped around the mixing chamber 26 or located within the mixing chamber 26. Alternatively, cooling may be provided by a heat sink such as a mass of aluminium or gel.

Referring now to FIG. 6, there is shown a fifth embodiment of a beverage dispense system in which the heat exchange device 9 is omitted and both the concentrate and diluent are supplied to the metering device 10 of the control unit 5 at ambient temperature. In this way, blending of the metered fluids in the mixing device 11 may be enhanced. In this embodiment, cooling of the beverage is provided in the mixing device 11 in similar manner to the previous embodiment (FIG. 5). It will be understood, however, that the beverage may be cooled in a separate conditioning unit 12 as previously described and shown in FIGS. 1, 3 and 4.

Referring now to FIG. 7 there is shown a sixth embodiment of a beverage dispense system in which the diluent is still water and the beverage is optionally carbonated after metering and mixing the diluent and concentrate. As shown, a source 19 of carbon dioxide is provided for carbonating the beverage in the conditioning device 12. For example device 12 may comprise a carbonator tank with a nozzle for injecting CO2 to carbonate the beverage. In this way the carbonation is effected after the diluent and concentrate have been mixed in the desired ratio to produce the required beverage. As a result, carbonation levels may be enhanced by absorption of carbon dioxide in both the diluent and concentrate. Moreover, the ratio of the mixed fluids and hence beverage quality is not adversely affected by variable carbonation levels in the diluent prior to metering and mixing. Also, carbonation levels in the dispensed beverage are not affected by the addition of uncarbonated concentrate to carbonated beverage and can be more accurately controlled in the beverage to be dispensed. Typically the beverage is carbonated to 3.5 to 4.5 volumes and it may be possible to obtain these carbonation levels with lower pressures of carbon dioxide. In this embodiment, the conditioning unit 12 may also cool the beverage to the required temperature for dispense by any of the methods described previously.

Referring now to FIG. 8 there is shown a seventh embodiment of a beverage dispense system in which the beverage components are mixed and optionally carbonated in the mixing device 11. The conditioning device 12 may be used to control the temperature of the beverage for dispense by any of the methods previously described.

Referring now to FIG. 9 there is shown an eighth embodiment of a beverage dispense system in which the conditioning device 12 is omitted and, where required, optional carbonation and/or additional cooling of the beverage is provided in the mixing device 11. For example, coolant may be circulated through coils wrapped around the mixing chamber 26 or located within the mixing chamber 26. Alternatively, cooling may be provided by a heat sink such as a mass of aluminium or gel.

Referring now to FIG. 10 there is shown a ninth embodiment of a beverage dispense system in which the heat exchange device 9 for cooling the diluent is omitted and both the concentrate and diluent are supplied to the metering device 10 at ambient temperature with optional carbonation and/or cooling of the beverage being provided in the mixing device 11 in similar manner to FIG. 9. It will be understood, however, that beverage cooling may be provided in a separate conditioning unit 12 as described previously and shown in FIGS. 7 and 8.

Referring now to FIG. 11 there is shown a tenth embodiment of the invention, which differs from that shown in FIG. 10 only in that the concentrate 6 and diluent 2 are mixed before they enter the mixing/blending device 1. The metered amount of concentrate and diluent leave the metering device in separate pipes or lines which converge before entry into the blending device 1. The mixed concentrate and diluent may optionally be carbonated, carbonation may occur in the pipe before the blending device, in the blending device or after leaving the blending device. The skilled man will appreciate that the feature of mixing the diluent and concentrate before they enter the blending device can be applied to all embodiments of the invention.

Referring now to FIG. 12 there is shown an eleventh embodiment of the invention in which a beverage dispense system is shown which is arranged to use three different concentrates 61, 62 and 63 to produce three separate beverages dispensed via three taps/dispensers 141, 142 and 143. Preferably each concentrate produces a different beverage. The system includes one source of diluent 2 which is supplied by line 7 to each of three different metering devices 101, 102 and 103 in the control unit 5. Each metering device 101, 102 and 103 is also feed by a line, 31, 32 or 33 respectively, arranged to deliver concentrate from a concentrate source, 61, 62 and 63 respectively, to the metering device 101, 102 and 103. The metering devices 101, 102 and 103 are arranged to measure the concentrate and diluent to be supplied to the respective blending devices 111, 112 and 113. The diluent 2 and concentrate 61, 62 and 63 leave the metering devices 101, 102 and 103 in separate lines, however these lines converge before they reach the blending devices 111, 112 and 113 such that the diluent and concentrate enter the blending devices in the same line. It will be appreciated that the concentrate and diluent could be delivered to the blending devices separately.

Once in the blending device 111, 112 and 113 the diluent 2 and concentrate 61, 62 and 63 are mixed and carbonated. Carbon dioxide to carbonate the mixed diluent and concentrate is supplied from a carbon dioxide source 19 via a line 22. In an alternative embodiment (not depicted) the mixed diluent and concentrate could be carbonated after being mixed, either in a separate carbonating device or in-line in a line/pipe.

From the blending devices 111, 112 and 113 the mixed and carbonated diluent and concentrate, now known as the beverage, is passed through a conditioning device 12. In the conditioning device 12 the beverage is cooled to the dispense temperature. The conditioning device 12 is shown to be separate from, that is outside, the control unit 5. However, it will be appreciated that the conditioning device 12 could be included in the control unit 5.

The beverage is then delivered to the beverage dispensers 141, 142 and 143 in lines 15 connected by outlets to the conditioning device 12. The lines 15 may be cooled to maintain the beverage at the desired temperature.

As discussed previously, in particular with reference to FIG. 1, the control unit in this, and indeed in all the examples, can be located at any point between the source of diluent and concentrate and the point of dispense. The skilled man will also appreciate that although this example depicts the preparation and dispense of three beverages the system could be amended to dispense any number of beverages.

In each of the beverage dispense systems shown in FIGS. 7 to 12, the control unit 5 is set up to dispense carbonated or uncarbonated beverages on installation of the unit 5 by connecting or disconnecting the source 19 of carbon dioxide as desired. Alternatively, a valve may be provided in the carbon dioxide supply line whereby the valve can be opened or closed according to whether the system is to dispense carbonated or uncarbonated beverages.

Referring now to FIG. 13 there is shown a twelfth embodiment of a beverage dispense system in which the diluent is still water and a three way valve 20 is provided between the mixing device 11 and conditioning device 12. Beverage from the mixing device 11 may be passed through the conditioning device 12 for carbonating and then to dispenser 14 for dispensing carbonated beverage in a first position of the valve 20. Alternatively, the beverage from the mixing device 11 may by-pass the conditioning device 12 for delivery to the dispenser 14 in line 21 for dispensing uncarbonated beverage. In this way, the same concentrate and diluent may be used to produce a carbonated or uncarbonated beverage for dispense in accordance with user selection via an appropriate interface. For example the control unit 5 may dispense still or carbonated orange juice.

In this embodiment, the beverage may be cooled in the mixing device 11 to the required temperature for dispense prior to the valve 20. Alternatively, the carbonated beverage may be cooled in the conditioning device 12 by any of the methods described previously and the uncarbonated beverage may be cooled in the line 21 by any suitable means.

In the above-described embodiments, the metering device 10, mixing device 11 and, where provided, conditioning device 12 are all provided in a single control unit 5 with appropriate connections for the fluid lines. As a result, the control unit 5 can be installed at any position in the dispense system between the fluid sources 2, 6 and the dispenser 14.

In a preferred arrangement, the metering device 10 is pre-set to provide the required ratio of diluent and concentrate according to the manufacturers specification for a given concentrate and the control unit 5 is arranged to prevent adjustments to the ratio by the end user (retailer). For example, the control unit 5 may be filled with foam insulation to reduce the effect of ambient temperature variations on the performance of the unit and to preclude access to the metering, mixing and where provided conditioning devices housed in the unit. In this way, the quality of the dispensed beverage is assured.

It will be understood however, that the devices 10 and 11 may be provided in a single control unit with the device 12 in a separate unit for installation when required. In another embodiment (not shown), the metering device 10 and mixing device 11 may be provided in separate units.

Referring now to FIG. 14, there is shown a thirteenth embodiment of a modular beverage dispense system according to the invention in which two control units 5, 5′ are combined in a modular unit for connection to appropriate sources of diluent and concentrate for dispensing two beverages according to user selection via an appropriate interface (not shown). For example, the metering devices 10, 10′ may be connected to a common source 2 of still water and to separate sources of concentrate 6,6′ with optional carbonation in the mixing device 11′ or conditioning device 12′. In this way, the unit 5 may supply uncarbonated beverage to the dispenser 14 and the unit 5′ may supply carbonated beverage to the dispenser 14.

It will be understood that a modular system may comprise any number of control units 5 to dispense any combination of carbonated or uncarbonated beverages as desired. It will also be understood that the modular system may employ any of the control units 5 previously described and shown in FIG. 1 and FIGS. 3 to 13 and that a modular system may comprise any combination of the same or different control units 5 according to user requirements.

In the above-described embodiments, the metering device 10 may be of any suitable type for measuring and supplying volumes of diluent and concentrate to the blending/mixing device 11 in the required ratio for the beverage to be dispensed. For example, the metering device 10 may comprise a ratio pump for both fluids or separate flow control valves for each fluid. The control unit 5 may include means for monitoring throughput of concentrate. The monitoring means may record the throughput for inspection/collection of data for stock control. Alternatively or additionally, the monitoring means may transmit the data for remote monitoring of the unit.

The two fluids may be a diluent and a concentrate for mixing to produce any desired beverage. The ratio of diluent to concentrate may be of the order of 5:1 to 4:1. It will be understood however that the invention has application to metering and mixing of any fluids to produce a beverage. In some applications more than two fluids may be metered and mixed to produce a desired beverage.

It will also be understood that the invention is not limited to the above embodiments which are intended to illustrate the diverse range and application of the invention to a variety of dispense systems and other modifications will be apparent to those skilled in the art. Furthermore, it will be apparent from the description already given that features of any of the dispense systems can be used separately or in combination with features of any of the other dispense systems to provide a dispense system having the benefits and advantages of the invention.

1. A beverage dispense system comprising a source of a first fluid, a source of a second fluid, a control unit for measuring and mixing the first and second fluids in a pre-determined ratio to produce a beverage for dispense, the control unit including measuring means for delivering the first and second fluids in the pre-determined ratio to blending means for mixing the first and second fluids, and supply means for supplying the beverage to dispense means for dispensing the beverage.

2. A system according to claim 1 in which the control unit for measuring and mixing the two fluids to produce the beverage is installed between the fluid sources and the dispense means.

3. A system according to claim 1 in which the control unit includes conditioning means for modifying one or more properties of the mixed fluids.

4. A system according to claim 3 in which the conditioning means alters the temperature of the beverage to be dispensed.

5. A system according to claim 3 in which the conditioning means controls the carbonation level of the beverage to be dispensed.

6. A system according to claim 3 in which the conditioning means is separate from the blending means.

7. A system according to claim 3 in which the conditioning means is combined with the blending means.

8. A system according to claim 1 in which the mixed fluids are carbonated for dispense of carbonated beverages.

9. A system according to claim 8 in which the carbonation level of the dispensed beverage is enhanced by absorption of carbon dioxide in both the diluent and concentrate.

10. A beverage dispense system comprising a source of a first fluid, a source of a second fluid, means for mixing the first and second fluids in a pre-determined ratio to produce a beverage for dispense, means for optionally carbonating the beverage, and supply means for supplying the beverage to dispense means for dispensing the beverage.

11. A system according to claim 10 in which the first and second fluids can be mixed to produce a beverage that can be dispensed as either a carbonated or uncarbonated beverage.

12. A system according to claim 10 in which the carbonating means is separate from the mixing means.

13. A system according to claim 10 in which the carbonating means is combined with the mixing means.

14. A system according to claim 10 in which the mixing means is separate from a metering means for supplying the fluids to the mixing means in the pre-determined ratio.

15. A system according to claim 10 in which the mixing means is combined with a metering means for supplying the fluids to the mixing means in the predetermined ratio.

16. A system according to claim 14 in which the metering means, mixing means and optional carbonating means are provided in a control unit for installation between the fluid sources and the dispense means.

17. A method of dispensing a beverage by providing sources of first and second fluids, providing means for mixing the first and second fluids in a pre-determined ratio, providing means for optionally carbonating the beverage, and providing means for dispensing either carbonated or uncarbonated beverage.
